(19) United States
(12) Patent Application Publication
(10) Pub. No.: US 2001/0052416 A1
(43) Pub. Date: Dec. 20, 2001

(54) Electric implement with tool

(76) Inventors: Walter Wissmach, Munich (DE); Ferdinand Kristen, Gilching (DE); Hans-Werner Bongers-Ambrosius, Munich (DE)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/867,088

(22) Filed: May 29, 2001

(30) Foreign Application Priority Data
Jun. 14, 2000 (DE) 100 29 133.3

(51) Int. Cl. B23Q 5/00

(52) U.S. Cl. 173/4

(57) ABSTRACT

An electrical device for driving a tool (1), is secured in a tool chuck (2) and contains data (6) characterizing the tool (1). The tool is driven by an electrical driving mechanism (10), and is equipped in the chucking region (4) with a transponder (5), which contains READ and/or WRITE data (6). The electrical device (3) contains a transmitting and receiving unit (7), connected with a microcontroller (8), which in turn is connected with the electrical driving mechanism (10).

### BACKGROUND OF THE INVENTION

The invention relates to an electrical device, such as a drill, a hammer drill, a chisel hammer, a circular saw, a core drilling machine, and the like, and a tool secured in the device.

When used appropriately, electrical devices are held in direct contact by the user, who is located partly in the force path and accordingly is necessarily in a position of possible danger. Consequently, safety aspects must always satisfy high requirements. The tool, as an active working part and, accordingly, in force-transmitting contact with the workpiece, plays a decisive role when considering the safety aspects.

By varying the operating conditions, modem electrical devices permit a large number of different tools to be used, the optimum operating conditions of which are different in each case and for the use of which different safety aspects must be taken into consideration. In addition, modem electrical devices have intelligent safety systems, for example, for limiting excessive rotation of the housing of the electrical device, which is held manually by the user.

According to U.S. Pat. No. 4,742,470, a transponder, integrated in the tool, is used to characterize different tools with a conical shaft of a stationary machine device, with the capability for automatically exchanging tools as well as for transferring data, which contain different parameters for adjusting optimum operating conditions, from the tool to the machine device as well as in the reverse direction, which parameters contain data concerning the stressing of the tool. A transmitting and receiving unit in the vicinity, which supplies the transponder with energy, can be in contactless READ and WRITE communication with the transponder. Safety-relevant data, relating to the direct user who is not disposed even partially in the path of the forces, are not transferred to the stationary machine tool.

The EP-0 721 820 discloses a tool in the form of a rock drill with a mechanical or geometric coding, which can be read and evaluated over mechanical, optical or magnetic sensors in the tool holding chuck of the associated electrical device. Especially the data range, which is limited significantly over a geometric coding, is a disadvantage of this solution. Aside from the optimum operating conditions, such as the rpm, the data range does not permit safety-related parameters, such as the maximum torque, to be transmitted. In addition, information such as a tool blockage, which stresses the tool greatly and is recorded by the electrical device, cannot be stored in the tool. Since the coding can be read only by the moving tool, the safety of the user possibly already has been endangered or, when a chisel is used in the switch position for drilling cutting, the user is at risk when the electrical device is started up.

### SUMMARY OF THE INVENTION

It is an object of the invention to provide, while avoiding the above disadvantages, a characterization of the tools, which is in accordance with the safety aspects of electrical device and can be read by the electrical device.

Essentially, in the chucking or clamping region, the tool, when used appropriately and taken up in a tool holding fitting or chuck of the electrical device, is equipped with a transponder, which contains data. For this purpose, the electrical device has a transmitting and receiving unit, which is connected via a microcontroller with the electrical driving mechanism.

Accordingly, the tool used can be identified by the electrical device immediately before the actuation of the electrical driving mechanism, advantageously during or already shortly before the insertion in the tool chuck or holding fitting, and, depending on the data received and its evaluation, appropriate adjustments can be made by the electrical device over electronic setting means, such as thyristor switches, servomotors, electric magnets, or over an assignment table in the microcontroller. For example, in the case of a combination hammer, it can be recognized whether the tool is a drill or a chisel and the electrical device can then be switched between drilling or chiseling.

Advantageously, aside from data for selecting an optimum operating state, for example, that with respect to the type of drill, such as a rock drill, and the drill diameter for selecting a suitable rpm by the microcontroller, data for ensuring safety-related settings or a limiting torque, are also transmitted. For this purpose, the microcontroller is connected over a safety module with the electrical driving mechanism and advantageously with further safety devices, such as a safety clutch.

Furthermore, for determining the stresses on the tool, the electrical device advantageously contains suitable sensors, for example, for measuring the time, the torque or the speed, the sensors being connected with the microcontroller. Loads, which are determined by these sensors and lead to high stresses on the tool and have an effect on the service life or the permissible time of use of the tool, are transmitted over the transmitting and receiving unit to the transponder in the clamping region of the tool and stored in this transponder individually and in a suitable manner.

Advantageously, the microcontroller and the safety module are contained at least partly in a microcontroller control system for the electrical driving mechanism, necessary, for example, when a switched magnetic reluctance motor is used. As a result, the number of components and component elements can be reduced.

Furthermore, a coil of the transmitting and receiving unit, acting as an antenna, is advantageously disposed close to the tool chuck of the electrical device, the high-frequency, electromagnetic field, generated by the coil, penetrating the transponder of a tool secured in the tool chuck with a field strength adequate for supplying power to the transponder and for bi-directional communication.

Preferably, the transponder is embedded in a vibration-absorbing material or disposed glued into a pocket in the chucking part of the tool.

The various features of novelty which characterize the invention are pointed out with particularity in the claims annexed to and forming a part of this disclosure. For a better understanding of the invention, its operating advantages and specific objects attained by it use, references should be had to the drawings and description matter in which there are illustrated and described preferred embodiments of the invention.

### BRIEF DESCRIPTION OF THE DRAWING

FIG. 1 is a side elevational view of an electrical device with a tool embodying the invention.

### DETAILED DESCRIPTION OF THE INVENTION

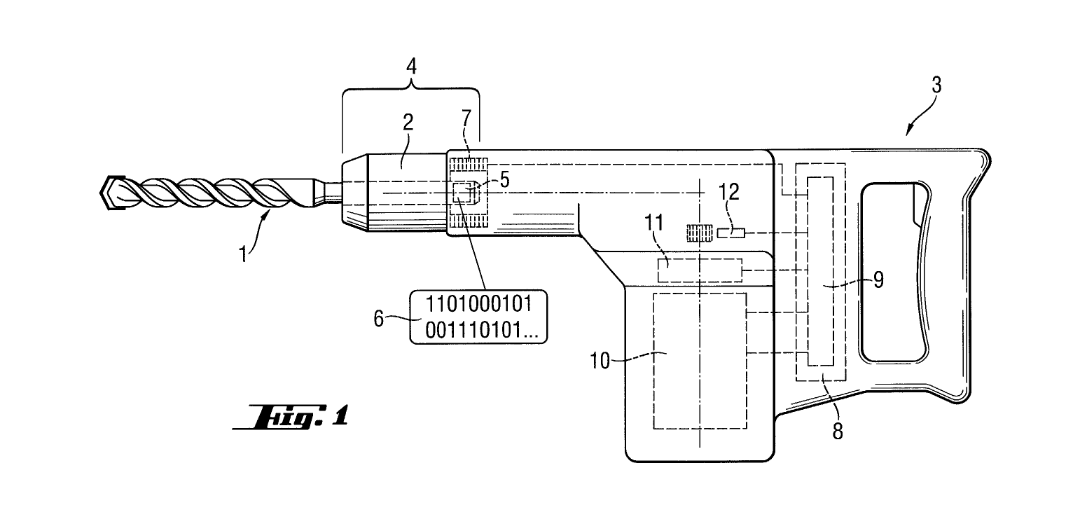

According to FIG. 1, an axially extending tool is secured at one end in a tool chuck 2 of an electrical device 3, the other end, the working end has a cutting member. The tool 1 is equipped at the one end, its chucking region 4, with a transponder 5 containing data 6. For this purpose, the electrical device 3 contains a transmitting and receiving unit 7, connected to a microcontroller 8 within the device. Over a safety module 9, incorporated in the microcontroller 8, it is connected with an electrical driving mechanism 10 located in the device 3, another safety device 11 and a sensor 12 are also located within the device. The microcontroller 8 is connected via a safety module 9 with means for setting the electrical driving mechanism 10. The safety module 9 is connected with the means for setting the drive mechanism 10 over another safety device 11 within the device 3.

The transponder 5 located in the one end of the tool, can contain READ and/or WRITE data 6. The data 6 represents at least partially the makeup of the tool.

What is claimed as new and desired to be protected by Letters Patent is set forth in the appended claims.

What is claimed is:

1. An electrical device for driving a tool (1) having a working end spaced outwardly from the device (3) and an opposite end secured in a tool chuck (2) of the device (3), an electrical driving mechanism (10) within the device (3) for driving said tool (1), a transmitting and receiving unit (7) within the device (3) in communication with a transponder (5) located in the opposite end of said tool (1) and containing data (6) characterizing said tool (1), a microcontroller (8) within the device (3) and connected to said transmitting and receiving unit (7), and said microcontroller (8) connected to said electrical driving mechanism (10) for operating said tool (1).

2. An electrical device, as set forth in claim 1, wherein said microcontroller (8) is connected via a safety module (9) with means for setting the electrical driving mechanism (10).

3. An electrical device as set forth in the claim 2, wherein the safety module (9) is connected to the means for setting the electrical driving mechanism (10) by a further safety device (11).

4. An electrical device, as set forth in claim 2, wherein said safety module (9) is connected to a sensor (12) located in the device (3).

5. An electrical device, as set forth in claim 2, wherein at least one of the further safety device (11) and the transmitting and receiving unit (7) is incorporated at least partially in the microcontroller (8).

6. An electrical device, as set forth in claim 2, wherein at least a part of the transmitting and securing unit (7) is formed as a coil and is located adjacent to the tool chuck (2).

7. A tool, for use in an electrical device, wherein said tool is axially extending and has a working end and an opposite end to be secured in a chuck (2) of the electrical device, a transponder (5) incorporated in the opposite end of said tool and containing at least one of READ and WRITE data (6).

8. A tool, as set forth in claim 7, wherein said data (6) at least partially discloses the makeup of said tool (1).
